(19) United States
(12) Patent Application Publication
(10) Pub. No.: US 2022/0225576 A1
(43) Pub. Date: Jul. 21, 2022

(54) COLLAPSIBLE PLANT CONTAINER SYSTEM AND METHOD OF USE

(71) Applicant: PLANTPOCKETS INTL LLC, Boca Raton, FL (US)

(72) Inventors: Kevin Bergman, Boca Raton, FL (US); Brian Fischer, Boca Raton, FL (US)

(21) Appl. No.: 17/561,904

(22) Filed: Dec. 24, 2021

Related U.S. Application Data
(60) Provisional application No. 63/130,466, filed on Dec. 24, 2020.
(60) Provisional application No. 63/236,689, filed on Aug. 24, 2021.

(51) Int. Cl. A01G 9/02

(52) U.S. Cl. CPC A01G 9/026

(57) ABSTRACT

A plant container system includes a collapsible container unit configured and dimensioned to contain an amount of soil needed to support the growth of a plant potted therein. The collapsible container unit is disposable between an operable expanded configuration and a collapsed configuration, and rolling up the free edge of the open top of the container unit can increase the capacity of container, allowing more soil to be put in. Therefore, growing a plant in the collapsible container may not require re-potting. Methods of growing plants using the plant container system are also provided.

### CROSS REFERENCE TO RELATED APPLICATIONS

This application claims priority to U.S. Provisional Application No. 63/130,466 filed Dec. 24, 2020 and U.S. Provisional Application No. 63/236,689 filed Aug. 24, 2021, the disclosure of each of which is incorporated herein by reference in its entirety.

### FIELD OF THE INVENTION

The present invention relates generally to a collapsible plant container system and uses thereof.

### BACKGROUND OF THE INVENTION

Home gardening in the United States is big business. In 2019, revenues from the sales of gardening equipment and supplies have been reported to be in excess of $80 billion. Additional data shows that nearly 1 in 3 persons in the United States engage in some form of gardening activity.

Many gardens begin by planting seeds in small containers and/or as seedlings also in small containers which may be purchased from a local nursery or obtained from a local co-op. The majority of the seeds which are being initially planted and/or the seedlings which are being initially obtained and transported are contained in some form of plastic container, plastic flowerpot, plastic tray, etc. A number of the plants obtained from these seeds or seedling, whether green plants, flowers, fruits, vegetables, or even shrubs or trees, are transplanted directly into an outdoor garden, and the plastic container, plastic flowerpot, plastic tray, etc., are simply discarded with other household trash for disposal in a local landfill.

As populations continue to become more and more concentrated in medium and large metropolitan areas, the availability of plots of land in which to plant a garden are becoming scarcer and scarcer. As such, many apartment and condominium dwellers, as well as owners of smaller properties, have increasingly expanding the practice of growing plants entirely in some form of pot and/or planter wherever some outdoor space is available, such as on a porch, or on a balcony, or on a landing, etc. As with the containers utilized to start seeds and/or to transport seedlings, many of these pots and/or planters are constructed of rigid impervious plastic materials of construction.

These rigid impervious plastic pots and/or plastic planters invariably prevent airflow through the soil contained therein, which is essential for a plant growing in such a pot or planter. More in particular, proper aeration of the soil facilitates a more efficient uptake of water and necessary nutrients to the plant through its root system. Further, aeration helps prevent the growth of mold which may results in rot and/or other damage to the root system, which ultimately results in damage, if not death, of the plant itself. This is particularly a problem with impervious plastic pots and/or plastic planters which typically provide nothing more than a single drain hole, or perhaps several drain holes, through the bottom thereof, which in many cases fails to provide sufficient water drainage therefrom, water retention being a major contributor to root rot.

In the case where a person is cultivating numerous types of plants, flowers, fruits, vegetables, etc., a considerable amount of space is typically required for storage of the various rigid plastic pots and/or plastic planters which a person utilizes during a growing season. This can create a significant inconvenience for some persons living in apartments and condominiums, or on smaller properties, and it can create an outright problem for others who may find no other alternative than to simply dispose of the rigid plastic pots and/or plastic containers for lack of space for proper storage thereof.

As will be appreciated from the foregoing, in view of the considerable volume of gardening equipment and supplies sold in the United States each year, it is apparent that large volumes of rigid impervious and non-degradable plastic pots, plastic planters, and other such plastic containers are being manufactured and ultimately disposed of in landfills across our country, and across the world. As is becoming increasingly more apparent, a result of the production and often improper disposal of these large volumes of plastic materials, is that tons upon tons of non-degradable micro-plastic particles are finding their way into the lowest reaches of the food chain and ultimately, making its way back up into the food we purchase, and prepare, and feed to our friends and families.

Accordingly, there is a need for a solution to one or more of the aforementioned problems and shortcomings in the current state of the art.

### SUMMARY OF THE INVENTION

The present invention is directed to a collapsible plant container system, and uses thereof.

In one aspect, a plant container system includes a collapsible plant container unit configured and dimensioned to contain an amount of soil (e.g., an amount needed to physically and/or nutritionally support the a plant potted therein), wherein the collapsible plant container unit can include a sidewall having an upper end and a lower end, an open top at least partially defined by the upper end of the sidewall, and a base disposed opposite the open top thereof and attached to the lower end of the sidewall. The collapsible plant container unit is disposable between an operable expanded (working or deployed) configuration and a collapsed (storage) configuration.

In some embodiments, the open top comprises a periphery having a free edge that can be rolled down and up, wherein rolling down the free edge decreases the capacity of the container unit for containing soil, and rolling up the free edge increases the capacity of the container unit for containing soil.

The collapsible plant container unit can include at least a sidewall and/or bottom that has a biodegradable material of construction. As used herein, a biodegradable material can include hemp, jute, burlap, coconut Coir, or synthetic biodegradable polymeric material, such as poly(lactic acid), that can degrade or decompose upon action of naturally existing elements, such as water, bacteria, certain enzymes, etc. The sidewall and/or the bottom can be made from a breathable fabric material (permeable to airflow therethrough). For example, the fabric material is knitted fabric with sufficiently large pore size and thread material strength to maintain the breathability of the fabric. In some embodiments, the fabric material containing a ripstop feature (such as specific knitted pattern) that can prevent unraveling of the knitted strands when the fabric is punctured or torn.

In some embodiments, the sidewall of the collapsible plant container unit can be constructed by a synthetic plastic material such as polyethylene or polypropylene, nylon, polyester, etc. In any event, the material of construction should sufficient tensile strength to contain the amount of soil needed to support the plant potted therein.

In some embodiments, the collapsible plant container unit can include at least one seam to form a sidewall from a material of construction. In some embodiments, the collapsible plant container unit may have a plurality of seams to form a sidewall from a material of construction.

In some embodiments, the collapsible plant container unit can include a side wall with two opposing edges that can be reversibly opened and closed from top to bottom, where the closure of the two opposing edges can be effected by a Velcro structure (hooks on one side and loops on the other) or a zipper structure.

In some embodiments, the collapsible plant container unit can include an upper end of the sidewall at least partially defining an upper periphery therearound.

In some embodiments, at least one reinforcement member is disposed around the sidewall proximate the open top of the collapsible plant container unit to facilitate maintaining the collapsible plant container unit in the operable expanded configuration. In some embodiments, no reinforcement member is present. The collapsible plant container unit can be maintained open by the volume of soil contained therein.

In some embodiments, the collapsible plant container system can include a reinforcement member including an outer reinforcement panel positioned around and along a portion of an outer surface of the sidewall. In some other embodiments, the collapsible plant container system can include a reinforcement member having an inner reinforcement panel positioned around and along a portion of an inner surface of the sidewall of the collapsible plant container unit. In certain embodiments, the collapsible plant container system can include a reinforcement member including an upper reinforcement portion positioned around and overtop a portion of an upper end of the sidewall of the collapsible plant container unit.

In some embodiments, a tensioning mechanism is included in the collapsible plant container unit which operable with the open top of the sidewall to further facilitate maintaining the collapsible plant container unit in the operable expanded configuration. The tensioning mechanism can include a tensioning member (e.g., a draw cord) disposed in a channel around the sidewall proximate the upper end thereof.

The present invention also provides methods of using the plant container system described in for growing plants.

These and other objects, features, and advantages of the present invention will become more readily apparent from the attached drawings and the detailed description of the embodiments, which follow.

### BRIEF DESCRIPTION OF THE DRAWINGS

The embodiments of the invention will hereinafter be described in conjunction with the appended drawings provided to illustrate and not to limit the invention, where like designations denote like elements, and in which:

FIG. 1 presents a perspective view of one illustrative embodiment of a plurality of collapsible plant containers of different capacities each disposed in a collapsed configuration, in accordance with the present invention;

FIG. 2 presents a top perspective view of the plurality of collapsible plant containers of FIG. 1 each disposed in an operable expanded configuration and containing an amount of soil therein, in accordance with the present invention;

FIG. 3 presents a perspective view of one illustrative embodiment of a small collapsible plant container disposed in an operable expanded configuration and containing an amount of soil with a small plant potted therein, in accordance with the present invention;

FIG. 4 presents a bottom perspective view of one illustrative embodiment of a collapsible plant container disposed in a partially collapsed configuration, in accordance with the present invention;

FIG. 5 presents a partial perspective view of one illustrative embodiment of a tensioning mechanism of a collapsible plant container disposed in a non-tensioning configuration, in accordance with the present invention;

FIG. 6 presents a front perspective view of one illustrative embodiment of a collapsible plant container including an inset illustrative of an enlargement of apportion of a woven material of construction thereof, in accordance with the present invention; and

FIG. 7 presents a perspective view of one illustrative embodiment of a large collapsible plant container disposed in an open operable expanded configuration and containing an amount of soil with a large plant potted therein and having a tensioning mechanism disposed in a tensioning configuration relative thereto, in accordance with the present invention.

FIG. 8A is a vertical cross-section view of an illustrative embodiment of a collapsible plant container unit in a first open operable expanded configuration.

FIG. 8B is a vertical cross-section view of an illustrative embodiment of a collapsible plant container unit in a second open operable expanded configuration by rolling up the free edge at the top of the container shown in FIG. 8A.

FIG. 8C is a vertical cross-section view of an illustrative embodiment of a collapsible plant container unit having an engagement member for immobilizing the container to the ground.

FIG. 8D shows schematic views of securing stakes that can be engaged with the engagement member of the collapsible plant container unit shown in FIG. 8C.

FIG. 8E shows an embodiment of the base of an embodiment of a collapsible plant container unit having an engagement hole that can be used to engage the securing stakes shown in FIG. 8D.

FIG. 9A is a photo of an illustrative embodiment of a collapsible plant container in an open operable expanded configuration.

FIG. 9B is a photo of the collapsible plant container shown in FIG. 9A by rolling up the free edge at the top of the container.

Like reference numerals refer to like parts throughout the several views of the drawings.

### DETAILED DESCRIPTION

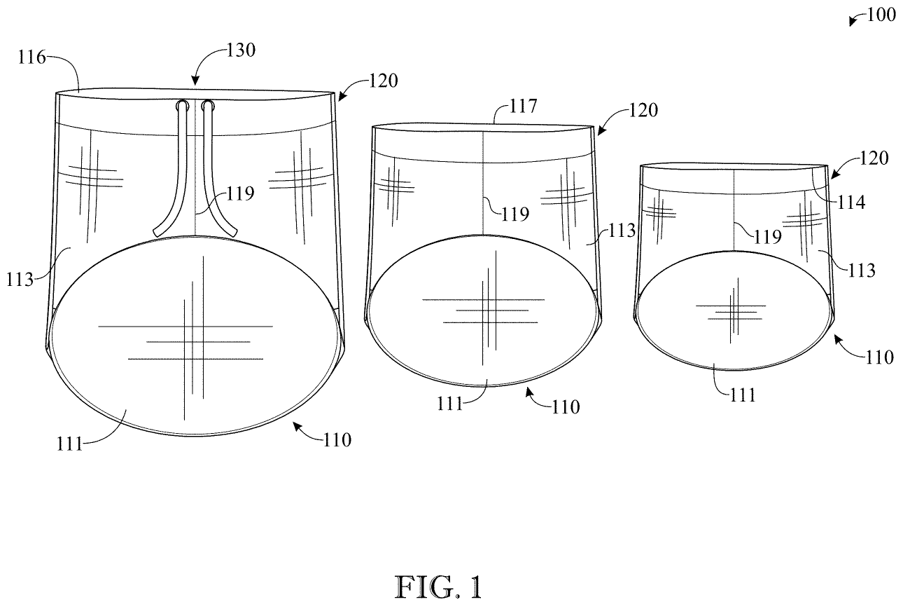

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “top”, “bottom”, “left”, “right”, “front”, “rear”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention provides a collapsible plant container, generally as shown as at 100 throughout the figures.

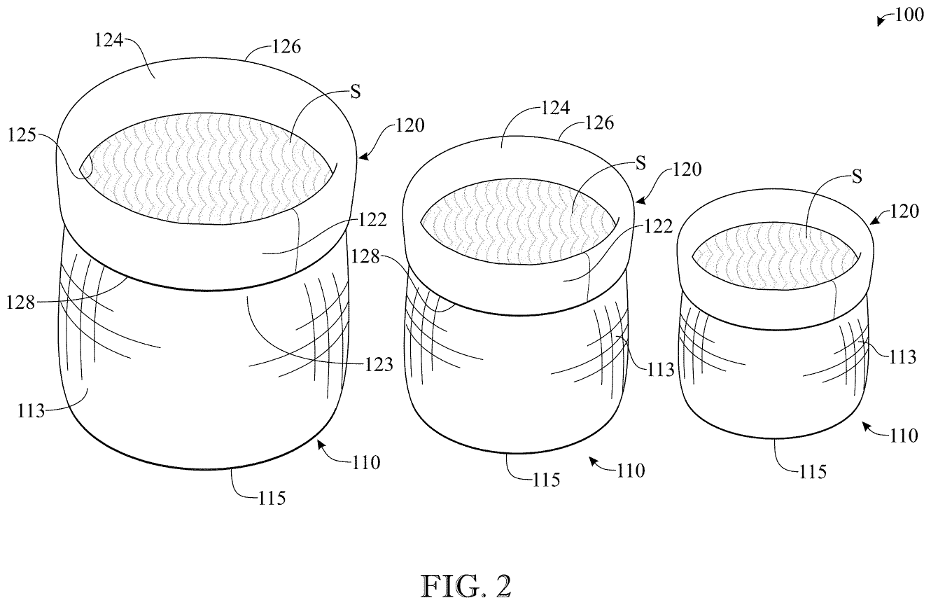

Referring initially to FIGS. 1 and 2, presented therein are perspective views of one illustrative embodiment of a plurality of collapsible plant containers 100 of different capacities each disposed in a collapsed configuration, and each disposed in an operable expanded configuration, respectively.

As may be seen from FIGS. 1 and 2, a collapsible plant container 100 in accordance with the present invention may be provided in any of a variety of sizes or capacities. Specifically, a collapsible plant container 100 in accordance with the present invention may be configured with a capacity to contain an amount of soil S as little as 1 pint, or 1 quart, or 1 gallon.

Conversely, a collapsible plant container 100 in accordance with the present invention may be configured with the capacity to contain an amount of soil S as large as 10 gallons, or 100 gallons, or 1,000 gallons, or more.

With particular reference to FIG. 1, a collapsible plant container 100 in accordance with the present invention comprises a collapsible plant container (or simply “collapsible container”) unit 110. A collapsible container unit 110 in at least one embodiment includes a sidewall 113 having upper end 114 and an oppositely disposed lower end 115, and a base (or base member) 111.

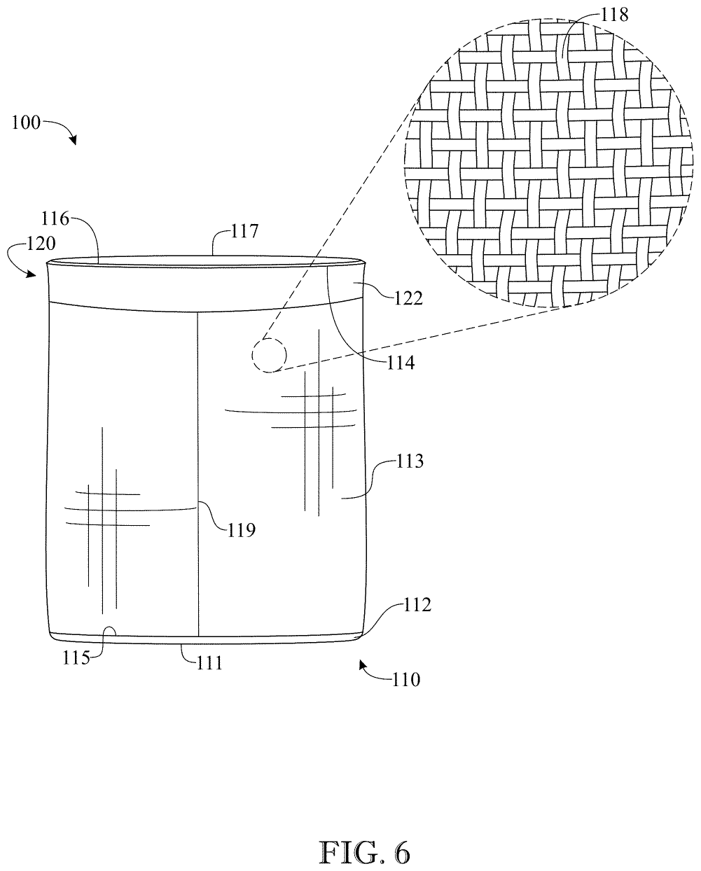

In an embodiment, a collapsible container unit 110 has an open top 116. As may be seen best in the illustrative embodiment of FIG. 6, an open top 116 is at least partially defined by an upper end 114 of the sidewall 113. More in particular, and with continued reference to the illustrative embodiment of FIG. 6, an upper end 114 of a sidewall 113 at least partially defines an upper periphery 117 disposed around the open top 116.

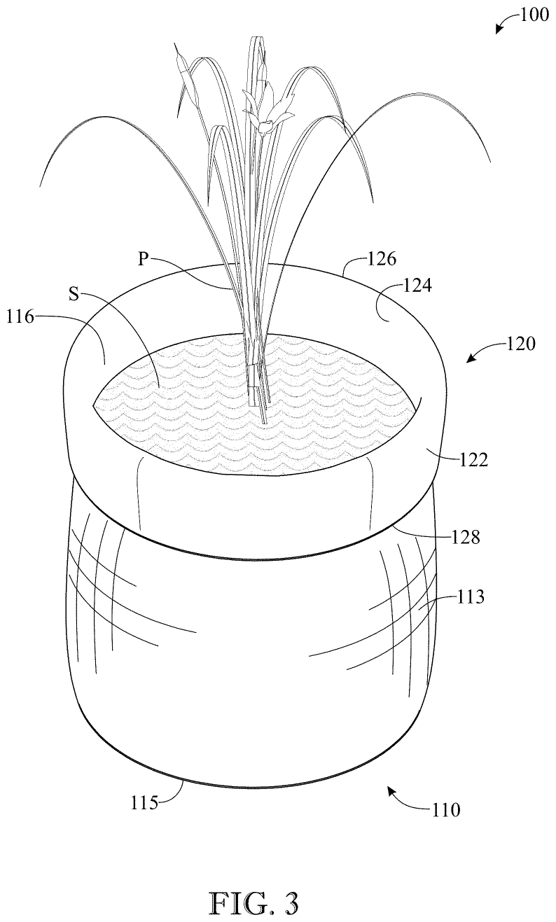

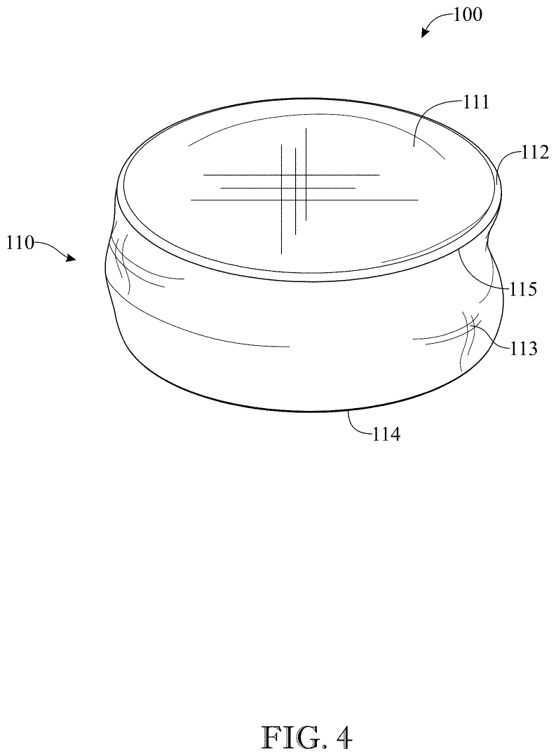

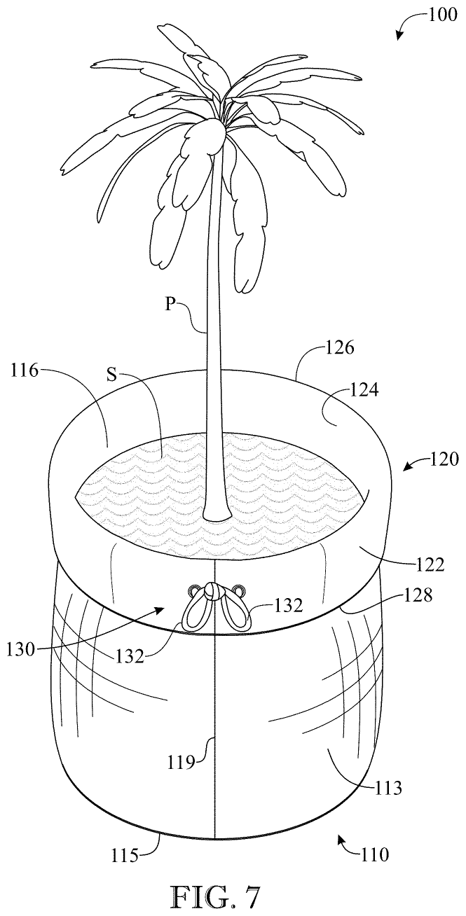

A sidewall 113 of a collapsible container unit 110 is constructed of a non-rigid flexible material of construction, so as to facilitate disposition of the collapsible container unit 110 from a collapsed configuration, such as is convenient for transport and/or storage, into an operable expanded configuration such that the collapsible container unit 110 can be filled with an amount of soil S sufficient to allow at least one plant P to be potted therein, such as is shown by way of example in the illustrative embodiments of FIGS. 3 and 7. Regardless, a sidewall 113 of a collapsible container unit 110 comprises a material of construction having sufficient tensile strength to contain the amount of soil S needed to support at least one plant P potted therein.

As such, in at least one embodiment, a sidewall 113 of a collapsible container unit 110 in at least one embodiment of the present invention is constructed of a fabric-like material which is non-rigid and flexible. Utilizing a fabric-like material of construction for a sidewall 113 of a collapsible container unit 110 facilitates assembly, as opposite sides of a sidewall 113 may be simply sewn together along a seam 119, so as to fully form the sidewall 113 of the collapsible container unit 110. A seam 119 in accordance with at least one embodiment of the present invention may be sewn with thread, string, twine, etc. As shown throughout the figures, a sidewall 113 of a collapsible container unit 110 comprises a generally cylindrical configuration, however, it is to be appreciated by those of skill in the art that it is within the scope and intent of the present invention for a sidewall 113 of a collapsible container unit 110 in accordance with the present invention to comprise any of a number of geometric configurations, for example, having a cross-sectional shape of a rectangle, ellipse, a polygon, or a regular polygon. In particular embodiments, for easy construction and horizontal packing/stacking, a square cross-section shape of the side-wall profile can be selected.

In one embodiment, at least a sidewall 113 (and/or the base member 111) of the collapsible container unit 110 is constructed of a biodegradable material such that the collapsible container unit 110 having an amount of soil S and one or more plants P potted therein to be buried in the ground without the need to remove the collapsible container unit 110 prior to doing so. More in particular, as the sidewall 113 is biodegradable, the roots of the plants P can readily expand and grow through and beyond the boundaries of the sidewall 113 once the plant(s) P and the collapsible container 110 are buried in the ground. In some embodiments, the container can be constructed entirely of biodegradable material.

In yet one further embodiment of a collapsible plant container 100 in accordance with the present invention, a sidewall 113 of a collapsible container unit 110 is constructed of a material which is permeable to air flow therethrough. As will be appreciated by those of skill in the art, providing aeration to the soil S contained in a collapsible container unit 110 through an air permeable sidewall 113 thereof in accordance with the present invention facilitates plant growth, by as much as 30% to 50%, as a result of air pockets created in the soil which enhance the transfer of water and nutrients to the root system, and thus, to the plant itself, as well as inhibiting damage from disease and/or overwatering thereof. In at least one embodiment, a sidewall 113 of a collapsible container unit 110 is constructed of a woven or knitted material such as, by way of example only, a woven polyethylene material, as is shown best in the illustrative embodiment of FIG. 6. In at least one embodiment, the spacing between the interwoven strands of polyethylene in a woven polyethylene material is approximately the size of a pinhead. In one embodiment, the spacing between the strands of a knitted polyethylene fabric is approximately the size of a pinhead.

A collapsible container unit 110 in accordance with the present invention further comprises a base member 111 disposed opposite an open top 116 thereof. Looking once again to FIG. 1, in at least one embodiment, a base member 111 comprises a circular configuration. However, and similar to a sidewall 113, it is to be appreciated that it is within the scope and intent of the present invention for a base member 111 to comprise any of a variety of geometric configurations, for example, an elliptical shape, a rectangular shape, a square shape, a polygonal shape (such as hexagon, octagon, etc.). Preferably, the shape of the base member should coincide with the cross-sectional shape of the side-wall.

A collapsible container unit 110 may also include a base attachment 112 structured to attach a base number 111 to a lower end 115 of a sidewall 113, such as is shown best in the illustrative embodiment of FIG. 6. In at least one embodiment, a base attachment 112 comprises sewing a base member 111 around and along a lower end 115 of a sidewall 113 of a collapsible container unit 110, similar to a seam 119 used the join opposite sides of a sidewall 113 to one another as described hereinabove. Also similar to a seam 119, a base attachment 112 may comprise sewing a base member III around and along a lower end 115 of the sidewall 113 with thread, string, twine, etc.

Similar to a sidewall 113 of a collapsible container unit 110, a base member 111 is constructed of a non-rigid flexible material of construction, so as to facilitate disposition of the collapsible container unit 110 from a collapsed configuration, such as is convenient for transport and/or storage, into an operable expanded configuration such that the collapsible container unit 110 can be filled with an amount of soil S sufficient to allow at least one plant P to be potted therein. As such, a base member 111 of a collapsible container unit 110 comprises a material of construction having sufficient tensile strength to contain the amount of soil S needed to support at least one plant P potted therein. Also similar to a sidewall 113 of a collapsible container unit 110 in accordance with the present invention, a base member 111 of the collapsible container unit 110 can be constructed of a biodegradable material such that the collapsible container unit 110 having an amount of soil S and one or more plants P potted therein to be buried in the ground without the need to remove the collapsible container unit 110 prior to doing so.

In some embodiments, the collapsible plant container 100 can include at least one reinforcement member 120 operably interconnected to a portion of a collapsible container unit 110. In at least one embodiment, a reinforcement member 120 is disposed around at least a portion of a sidewall 113 of a collapsible container unit 110 proximate an open top 116 of the collapsible container unit 110 such as is shown best in FIGS. 1, 3, 6 and 7. More in particular, at least one reinforcement member 120 is disposed around a sidewall 113 of a collapsible container unit 110 proximate an open top 116, so as to facilitate maintaining the collapsible container unit 110 in an operable expanded configuration, once again, such as is shown best in FIGS. 1, 3, 6 and 7.

In at least one embodiment of a collapsible plant container 100 in accordance with the present invention, a reinforcement member 120 comprises an outer reinforcement panel 122 which is disposed around and along an outer sidewall surface 123 of a sidewall 113 of a collapsible container unit 110, as may be seen throughout the figures. As further shown in FIG. 2, in at least one further embodiment a reinforcement member 120 further comprises an inner reinforcement panel 124 disposed around and along an inner side wall surface 125 of the sidewall 113 of the reinforcement attachment 120. In at least one further embodiment, a reinforcement member 120 further comprises an upper reinforcement portion 126 which is disposed along and around an upper end 114 of the sidewall 113 of a collapsible container unit 110, such as is shown throughout. In at least one embodiment, an outer reinforcement panel 122, an inner reinforcement panel 124 and an upper reinforcement portion 126 comprise a unitary construction.

In at least one embodiment, a reinforcement member 120 comprises a reinforcement attachment 128, such as may be seen in FIG. 2. Similar to a base attachment 112 and a seam 119 in accordance with the present invention, a reinforcement attachment 128 may comprise sewing a portion of an outer reinforcement panel 122 and/or an inner reinforcement panel 124 to a portion of the sidewall 113 of a collapsible container unit 110. Also similar to a base attachment 112 and a seam 119, a reinforcement attachment 128 may comprise sewing a portion of an outer reinforcement panel 122 and/or an inner replacement panel 124 to a portion of a sidewall 113 of a collapsible container unit utilizing thread, string, twine, etc.

A reinforcement member 120, and more in particular, an outer reinforcement panel 122, an inner reinforcement panel 124 and/or an upper reinforcement portion 126, are constructed of a material exhibiting greater rigidity and less flexibility than a material of construction of a sidewall 113 to which it is attached. As such, the greater rigidity of the reinforcement member 120, and once again, more in particular, an outer reinforcement panel 122, an inner reinforcement panel 124 and/or an upper reinforcement portion 126, will tend to retain an open top 116 of a collapsible container unit 110 in an operable expanded configuration when the collapsible container unit 110 is filled with an amount of soil S into which one or more plants P are potted.

At least one further embodiment of a collapsible plant container 100 in accordance with the present invention comprises a plurality of reinforcement members 120 disposed around a sidewall 113 of a collapsible container unit 110 at various spaced apart positions between an upper end 114 and a lower end 115 of the sidewall 113. As will be appreciated, providing a plurality of reinforcement members 120 around a sidewall 113 of a collapsible container unit 110 will further facilitate maintaining the collapsible container in an operable expanded configuration when the collapsible container unit 110 is filled with an amount of soil S into which one or more plants P are potted therein.

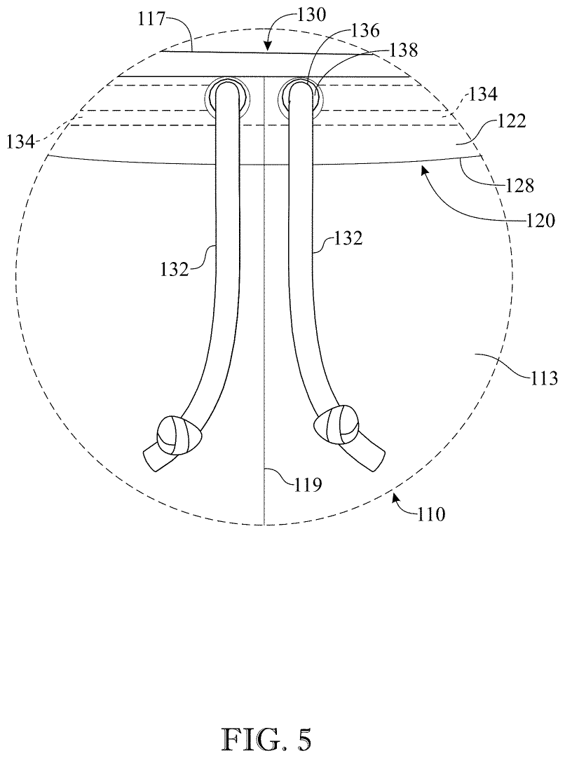

A collapsible plant container 100 in accordance with the present invention may further comprise a tensioning mechanism 130 which is operable with an open top 116 of the sidewall 113 of the collapsible container unit 110 to further facilitate maintaining the collapsible container unit 110 in operable expanded configuration once it is filled with an amount soil S. A tensioning mechanism 130 is typically employed on a collapsible container unit 110 having a larger volume capacity such as, by way of example only, 10 gallons, 20 gallons, 30 gallons and more. With reference to FIG. 5, a tensioning mechanism 130 in accordance with at least one embodiment of the present invention comprises a tensioning member 132 which is disposed around and along a sidewall 113 proximate an upper periphery 117 thereof. In at least one embodiment, a tensioning mechanism 130 comprises a tensioning member channel 134 wherein at least a portion of a tensioning member 132 is disposed within a tensioning member channel 134. With reference once again to the illustrative embodiment of FIG. 5 a tensioning member channel 134 is formed between a portion of an outer reinforcement panel 122 of a reinforcement member 120 and a portion of a sidewall 113 of a collapsible container unit 110 proximate an upper periphery 117 thereof.

In at least one embodiment, a tensioning mechanism 130 comprises a channel aperture 136 through which at least a portion of a tensioning member 132 is disposed into and out of a tensioning member channel 134. In still one further embodiment, a tensioning mechanism 130 comprises a channel aperture reinforcement 138 disposed around and about a channel aperture 136 so as to provide structural integrity thereto. As one example, a channel aperture reinforcement 138 may comprise a grommet affixed around a channel aperture 136. As another example, a channel aperture reinforcement 138 comprise stitching along and around an open periphery of a channel aperture 136 so as to prevent stretching or tearing thereof, by movement of a tensioning member 132 therethrough.

Looking next with reference to the illustrative embodiment of FIG. 7, a collapsible plant container 100 comprising a collapsible container unit 110 having a considerable volume so as to contain an amount of soil S sufficient to support a large plant P, in this case, a palm tree, potted therein. As may be seen from FIG. 7, the collapsible plant container 100 includes a reinforcement member 120 disposed around and along an open top 116 of the large capacity collapsible container unit 110. As before, a reinforcement member 120 is provided proximate an open top 116 of the collapsible container unit 110 to facilitate maintaining the collapsible container unit in an operable expanded configuration. As further seen in FIG. 7, the collapsible plant container 100 further comprises a tensioning mechanism 130 which is also disposed around and along an open top 116 of the large capacity container unit 110. As may be further seen from FIG. 7, opposite ends of a tensioning member 132 are interconnected, more specifically, tied to one another, so as to maintain at least an outer reinforcement panel 122 of the reinforcement member 120 in operative configuration disposed around and along the sidewall 113 of the collapsible container unit 110 proximate the open top 116 thereof, once again, so as to maintain the collapsible plant container 110 in an operable expanded configuration.

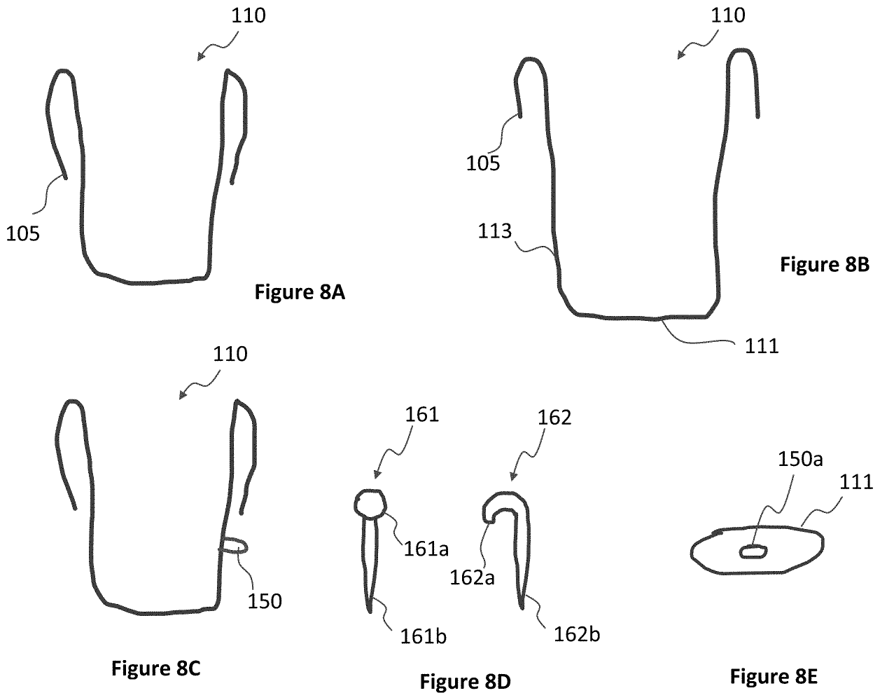

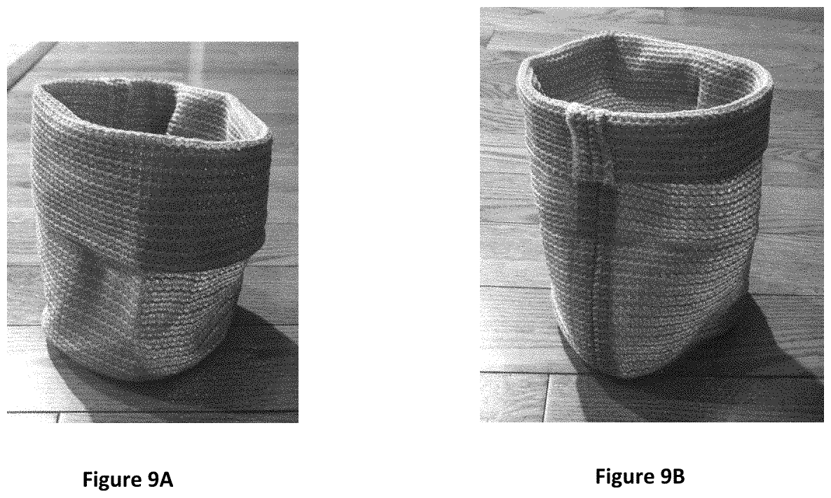

As illustrated in FIGS. 8A-8B, which are vertical cross-sectional views of an embodiment of a plant container system of the present invention, comprising a collapsible container unit 110 configured and dimensioned to contain an amount of soil needed to support a plant potted therein. The collapsible container unit 110 includes a sidewall having an upper end and a lower end; an open top at least partially defined by said upper end of said sidewall; and a base disposed opposite the open top thereof and attached to said lower end of said sidewall. The collapsible container unit 110 is disposable between an operable expanded configuration and a collapsed configuration. The open top comprises a periphery having a free edge 105 that can be rolled down and up, where rolling down the free edge decreases the capacity of the container unit for containing soil (FIG. 8A), and rolling up the free edge increase the capacity of the container unit for containing soil (FIG. 8B). FIG. 9A is a photo of such an embodiment of collapsible container unit in an open operable expanded configuration, and FIG. 9B is a photo of the collapsible plant container unit shown in FIG. 9A by rolling up the free edge at the top of the container unit. The lower-capacity configuration of the collapsible container unit can be used for a plant at a younger age, whereas the greater-capacity configuration can be used for the plant at later growth stages. By simply rolling up the free edge of the periphery at the top, a planter can add additional soil to the plant container unit as the plant grows, obviating the need to switching to a larger planting pot during the plant growth. Additionally or alternatively, the collapsible container unit can also be constructed with an expandable material or construction, where adding more soil into the container unit can expand the container unit (i.e., in the horizontal direction, in addition or alternative to the vertical direction) to accommodate a plant at a later growth stage.

As shown in FIG. 8C, the collapsible container unit can further include an engagement element 150 (e.g., an attached loop on the outer sidewall) for improving the stability of the collapsible container unit in the deployed configuration in exposed weather, e.g., during a storm. The plant container system can further include a securing stake 161 or 162 (FIG. 8D), which includes an enlarged top portion (161a) or a bent top portion (162a) to engage the engagement element 150, and a pointed end (161b and 162b) which can be used to be driven to the ground. More than one engagement element 150 can be provided on the collapsible plant container unit, e.g., at a similar height around the sidewall of the container unit, and a plurality securing stakes can be used, each to engage one of the engagement elements. The securing stake can be biodegradable polymeric material, or alternatively, be constructed with common synthetic plastic, metal, metal alloy, wood, or other materials as desired or needed. Alternatively, the engagement element on the collapsible container unit can be a hole 150a (e.g., a grommeted hole) at the base 111 of the collapsible container unit, as shown in FIG. 8E. Alternatively, the collapsible plant container unit does not need to include particular engagement element, and the securing stakes can be directly used to driven through the base of the collapsible plant container unit and into the ground, thereby securing the collapsible plant container unit onto the ground.

In a further aspect, the present disclosure provides a method of protecting a conventional non-collapsible plant pot (e.g., a plant container constructed of hard plastics or pottery) by a collapsible container system described herein. The method includes placing the non-collapsible plant pot (with the plant therein) into a collapsible container unit described herein, thereby providing the non-collapsible plant pot with a protective covering.

In a further aspect, the present disclosure provides a method of growing a plant, which includes: in a collapsible plant container unit of a plant container system described herein, placing an amount of soil and at least one seed or a plant at a first growth stage; allowing the at least one seed or plant to grow in the first plant container system to a second, later growth stage having a root system; placing at least a second plant container system containing at least an amount of soil adjacent to the first plant container system, such that at least a portion of the root system of the plant in the first plant container system grows into the soil in the second plant container system (the collapsible container unit having permeable side wall made of breathable fabric, allowing the plant root to penetrate through). A plurality of additional collapsible plant container units can be packed or stacked adjacent the first collapsible plant container unit, e.g., to sandwich the first plant container unit or to surround the first plant container unit.

In a further aspect, the present disclosure provides a method of growing a plant, which includes: in a first collapsible plant container unit of a first plant container system described herein, placing an amount of soil and at least one seed or a plant at a first growth stage; allowing the at least one seed or plant to grow in the first plant container system to a second, later growth stage having a root system; placing the first collapsible plant container unit of the first plant container system into a second collapsible plant container unit of a second plant container system, the second collapsible plant container unit having a greater volume than the first collapsible plant, without removing the plant or soil from the first collapsible plant container unit of the first plant container system; and adding an amount of soil into the second collapsible plant container unit (e.g., into the vacant volume in the second collapsible plant container unit that has not been occupied by the first collapsible container unit).

In a further aspect, the present disclosure provides a method of growing a plant, which includes: in a collapsible plant container unit of a plant container system described herein, placing an amount of soil and at least one seed or a plant at a first growth stage; and securing the collapsible plant container unit of the plant container system onto the ground, e.g., by a securing stake described herein.

The present disclosure also provides a method of protecting a plant containing planting pot, by placing a plant containing planting pot into a collapsible plant container unit of a plant container system described herein.

The present disclosure further provides a method of transplanting a plant growing in a (conventional hard plastics) planting pot containing an amount of soil, comprising: removing the plant and soil from the planting pot and placing the plant and soil into a collapsible plant container unit of a plant container system as described herein.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

1. A plant container system comprising:
a collapsible plant container unit configured and dimensioned to contain an amount of soil, including:
a sidewall having an upper end and a lower end;
an open top at least partially defined by said upper end of said sidewall;
a base disposed opposite said open top thereof and attached to said lower end of said sidewall;
the collapsible plant container unit being disposable between an operable expanded configuration and a collapsed configuration;
wherein the open top comprises a periphery having a free edge that can be rolled down and up, wherein rolling down the free edge decreases the capacity of the collapsible plant container unit for containing soil, and rolling up the free edge increase the capacity of the collapsible plant container unit for containing soil.

2. The plant container system of claim 1, further comprising a securing stake configured to engage with the collapsible container unit to immobilize the collapsible container unit to the ground.

3. The plant container system of claim 2, wherein the collapsible plant container unit further comprises at least one attached loop on the sidewall, and the stake is configured to engage with the attached loop on a first end and a pointed tip on a second end to be driven into the ground.

4. The plant container system of claim 2, wherein the collapsible plant container unit further comprises a hole in the base, and the stake is configured to engage with the hole on a first end and a pointed tip on a second end to be driven into the ground

5. The plant container system of claim 2, wherein the securing stake is biodegradable.

6. The plant container system of claim 1, wherein at least one of the sidewall and base or both of the sidewall and base of the collapsible plant container unit is constructed of a knitted fabric.

7. The plant container system of claim 1, wherein at least one of the sidewall and base or both of the sidewall and base of the collapsible plant container unit is made from polyethylene.

8. The plant container system of claim 1, wherein at least one of the sidewall and base or both of the sidewall and base of the collapsible plant container unit is made from a flexible biodegradable material.

9. The plant container system of claim 1, wherein the sidewall of the collapsible plant container unit is made from an expandable material or construction.

10. A plant container system comprising:
a collapsible container unit configured and dimensioned to contain an amount of soil, including:
a sidewall having an upper end and a lower end;
an open top at least partially defined by said upper end of said sidewall;
a base disposed opposite said open top thereof and attached to said lower end of said sidewall;
the collapsible container unit being disposable between an operable expanded configuration and a collapsed configuration; and
at least one or both of:
at least one reinforcement member disposed around the sidewall proximate the open top of the collapsible container unit to facilitate maintaining said collapsible container unit in the operable expanded configuration; and
a tensioning mechanism operable with the open top of the sidewall to facilitate maintaining the collapsible container unit in the operable expanded configuration.

11. A method of growing a plant, comprising:
in a collapsible plant container unit of a plant container system of claim 1, placing an amount of soil and at least one seed or a plant at a first growth stage;
allowing the at least one seed or plant to grow in the plant container system to a second, later growth stage;
rolling up the free edge of the collapsible container unit and adding additional amount of soil into the collapsible container unit; and
allowing the plant to grow to a third, later growth stage.

12. A method of growing a plant, comprising:
in a collapsible plant container unit of a plant container system of claim 1, placing an amount of soil and at least one seed or a plant at a first growth stage;
allowing the at least one seed or plant to grow in the plant container system to a second, later growth stage;
placing additional amount of soil into the collapsible container unit so as to expand the cross section of collapsible container unit of the plant container system; and
allowing the plant to grow to a third, later growth stage.

13. A method of growing a plant, comprising:
in a collapsible plant container unit of a first plant container system of claim 1, placing an amount of soil and at least one seed or a plant at a first growth stage;
allowing the at least one seed or plant to grow in the first plant container system to a second, later growth stage having a root system;
placing at least a second plant container system of claim 1 containing at least an amount of soil adjacent to the first plant container system, such that at least a portion of the root system of the plant in the first plant container system grows into the soil in the second plant container system.

14. A method of growing a plant, comprising:
in a first collapsible plant container unit of a first plant container system of claim 1, placing an amount of soil and at least one seed or a plant at a first growth stage;
allowing the at least one seed or plant to grow in the first plant container system to a second, later growth stage having a root system;
placing the collapsible plant container unit of the first plant container system into a second collapsible plant container unit of a second plant container system, the second collapsible plant container having a greater volume than the first collapsible plant container unit, without removing the plant or soil from the first collapsible plant container unit of the first plant container system; and
adding an amount of soil into the second collapsible plant container.

15. A method of growing a plant, comprising:
in a collapsible plant container unit of a plant container system of claim 2, placing an amount of soil and at least one seed or a plant at a first growth stage; and
securing the collapsible plant container unit of the plant container system onto the ground by a securing stake.

16. A method of protecting a plant containing planting pot, comprising:
placing a plant containing planting pot into a collapsible plant container unit of a plant container system of claim 1.

17. A method of transplanting a plant growing in a planting pot containing an amount of soil, comprising:
removing the plant and soil from the planting pot and placing the plant and soil into a collapsible plant container unit of a plant container system of claim 1.
